(19) United States
(12) Patent Application Publication
(10) Pub. No.: US 2018/0150840 A1
(43) Pub. Date: May 31, 2018

(54) ONLINE FINANCIAL TRANSACTION IDENTITY AUTHENTICATION SYSTEM USING REAL CARD, AND METHOD THEREOF

(71) Applicant: MALSAENG CO., LTD., Seoul (KR)

(72) Inventor: Han Uk JOUNG, Seoul (KR)

(73) Assignee: Malsaeng Co., Ltd., Seoul (KR)

(21) Appl. No.: 15/547,377

(22) PCT Filed: Jan. 28, 2016
(86) PCT No.: PCT/KR2016/000924

§ 371 Date: Dec. 23, 2017

(30) Foreign Application Priority Data
Jan. 28, 2015 (KR) 10-2015-0013560
Jan. 27, 2016 (KR) 10-2016-0010223

(51) Int. Cl. G06Q 20/40; G06Q 20/32; G06Q 20/34

(52) U.S. Cl. CPC G06Q 20/4014; G06Q 20/352; G06Q 20/3223

(57) ABSTRACT

Disclosed are an online identity authentication system using a real card, and a method thereof. The present invention enables identity authentication to be conducted by using a user's real bank card at the time of a mobile financial transaction using a smart phone such that a financial transaction can be conducted as if the financial transaction is conducted at an ATM of an offline bank, without an authentication certificate being saved separately. Accordingly, the present invention enables online financial transactions to be more conveniently conducted and security to be maintained. In addition, when identity is authenticated, a real bank card is read at a card reader unit and credit card information is transmitted, and thus the present invention has an advantage of enabling secure payments to be conducted without the risk of hacking.

### CROSS-REFERENCE TO RELATED APPLICATIONS

This patent application is a national-stage application of International Patent Application No. PCT/KR2016/000924 filed on Jan. 28, 2016 that claims priority under 35 U.S.C. § 119 to Korean Patent Application Nos. 10-2015-0013560, filed on Jan. 28, 2015, and 10-2016-0010223, filed on Jan. 27, 2016, in the Korean Intellectual Property Office, the disclosures of which are incorporated by reference herein in their entireties.

### TECHNICAL FIELD

The present invention relates to an identity authentication system and method for online financial transactions, and more specifically, an online financial transaction identity authentication system and method using a physical card, which may perform identity authentication using a physical bank card, but not via use of a certificate, eliminating the need for the user carrying his certificate or remembering the password.

### DISCUSSION OF RELATED ART

As smartphones are recently spreading, more attention is drawn to mobile transactions using smartphones. Use of smartphones enables financial transactions anytime, anywhere. Financial transactions via mobile devices, also known as smart banking, are thus expected to overtake existing financial transactions via PCs

Smart banking typically requires execution of an application installed on the smartphone and identity authentication via a certificate.

Oftentimes, customers delete and reinstall the application on the smartphone, exchange USIM chips or smartphones, or forget their phone number.

In such cases, they need reinstall the certificate and proceed with identity authentication to do electronic financial transactions. In doing so, a request for issuing a certification should be sent via a PC to the certificate center of the financial organization, which is quite burdensome.

Due to the possibility of user-desired applications being downloaded and installed, smartphones, like PCs, are at risk of being hacked by malicious code-embedded programs. Conventional PC-based Internet banking also suffers from serious security issues with a chance of the certificate stored in the hard disk being copied or leaked any time. To address such issues, Ministry of Public Administration and Security, South Korea, has prohibited saving certificate in hard disk since 2013, planning a policy for saving certificate in a security token, which is safe.

It is limited to apply various security programs, e.g., vaccine programs, keyboard security programs, anti-phishing programs, or firewall programs, which are intended for Internet banking via PCs, to smartphones for security of mobile banking. Unlike PCs with open platform (operating system and hardware environment), smartphones come with various independent platforms per manufacturer, rendering it difficult or impossible to convert or apply security programs intended for PCs to smartphones. The security programs, although able to be applied to smartphones, cannot completely prevent hacking. Further, smartphones, which have limited hardware capability as compared with PCs, may experience speed drops when several security programs are simultaneously installed, causing it reluctant to use mobile banking. Moreover, smartphones are also at high risk of leakage of certificate as are PCs saving certificate in the hard disk.

### SUMMARY

The present invention aims to address the problems with the conventional art. An objective of the present invention is to provide an online financial transaction identity authentication system and method using a physical card, which allows the user to be authenticated using his physical bank card, enabling financial transactions as if financial tasks are conducted through an ATM even without the need for getting a certificate separately saved. By so doing, online financial transactions may be performed in a more easy and secure manner.

Another objective of the present invention is to provide an online financial transaction identity authentication system and method using a physical card featuring safe payment without concern about hacking by allowing the card reader unit to read the physical bank card and transmit identification information about the physical bank card.

However, the present invention is not limited to the foregoing objects, and other objects will be apparent to one of ordinary skill in the art from the following detailed description.

To achieve the objectives, there is provided a system for online identity authentication using a physical card, the system comprising: a user terminal having a smart banking application installed thereon, receiving identification information about a physical bank card from a card reader unit to verify validity of the card and user identity, performing identity authentication based on the verified validity of card and user identity, and if the identity authentication is complete, transmitting the received identification information about the physical bank card to a bank server capable of processing a financial task through the smart banking application; and the card reader unit reading the physical bank card issued from a particular bank and inputting the identification information about the physical bank card to the user terminal.

In a preferred embodiment, the card reader unit is a card reader that includes a contacting unit that, when contacted by the physical bank card, reads the identification information about the physical bank card and a connecting unit connected with the user terminal to transmit the identification information about the physical bank card read by the contacting unit to the user terminal.

In a preferred embodiment, the card reader unit includes a proximity communication unit that may read the identification information about the physical bank card from the physical bank card contacted or approached.

According to the present invention, there is provided a method for online identity authentication when an application capable of an electronic financial transaction is executed on a user terminal, the method comprising the steps of: reading identification information about a physical bank card through a card reader unit; inputting a password of the physical bank card to the user terminal; encrypting the identification information about the physical bank card and the password and transmitting the encrypted information and password to a bank server by the user terminal; and comparing, by the bank server, the transmitted card identification information and password with pre-stored data to perform the identity authentication, and if the identity authentication succeeds, performing login to make a connection with the bank server or complete a transaction.

In a preferred embodiment, the method further comprises the step of connecting the card reader unit to the user terminal.

In a preferred embodiment, the card reader unit is a card reader that includes a contacting unit that, when contacted by the physical bank card, reads the identification information about the physical bank card and a connecting unit connected with the user terminal to transmit the identification information about the physical bank card read by the contacting unit to the user terminal.

In a preferred embodiment, the step of connecting the card reader unit to the user terminal is performed by connecting the connecting unit of the card reader unit to a connecting terminal of the user terminal, and the step of reading the identification information about the physical bank card through the card reader unit includes the steps of reading the identification information about the physical bank card from a magnetic part or IC chip part of the physical bank card contacting or swiped through the contacting unit and transmitting the identification information about the physical bank card through the connecting unit to the user terminal.

In a preferred embodiment, the card reader unit is a proximity communication unit embedded and installed in the user terminal.

In a preferred embodiment, the step of reading the identification information about the physical bank card through the card reader unit includes the steps of reading the identification information about the physical bank card from the physical bank card contacting or approaching the proximity communication unit, by the proximity communication unit, and transmitting the identification information about the physical bank card to the user terminal.

As such, according to the present invention, the user's identity authentication is performed using his physical bank card, eliminating the need for saving and carrying a certificate in the smartphone. Upon identity authentication, the card reader unit reads the physical bank card and transmits credit card information, enabling hacking-free, safe transaction or payment.

Further, identity authentication is carried out by allowing the card reader unit to read the physical bank card, inputting the password through the user terminal, and transmitting the information and password, which is the same way as does the user through an ATM, e.g., inserting his bank card to the ATM and entering the password, thereby getting the user used to online financial transactions.

Other effects of the present invention will be apparent to one of ordinary skill in the art from the following detailed description.

### BRIEF DESCRIPTION OF THE DRAWINGS

FIG. 1 is a flowchart schematically illustrating an example of identity authentication performed by an online financial transaction identity authentication system using a physical card according to a preferred embodiment of the present invention;

FIG. 2 is a view illustrating a configuration of a card reader externally connected to a user terminal as an example implementation of a card reader unit in an online financial transaction identity authentication system using a physical card according to a preferred embodiment of the present invention; and

FIG. 3 is a view illustrating a configuration in which a proximity communication unit is installed inside a user terminal as another example implementation of a card reader unit in an online financial transaction identity authentication system using a physical card according to a preferred embodiment of the present invention.

### EXEMPLARY EMBODIMENTS OF THE PRESENT INVENTION

Various changes may be made to the present invention, and the present invention may come with a diversity of embodiments. Some embodiments of the present invention are shown and described in connection with the drawings. However, it should be appreciated that the present invention is not limited to the embodiments, and all changes and/or equivalents or replacements thereto also belong to the scope of the present invention.

The terms “first” and “second” may be used to describe various components, but the components should not be limited by the terms. The terms are used only to distinguish one component from another. For example, a first component may be denoted a second component, and vice versa without departing from the scope of the present disclosure.

The terms as used herein are provided merely to describe some embodiments thereof, but not to limit the present disclosure. It is to be understood that the singular forms “a,” “an,” and “the” include plural references unless the context clearly dictates otherwise. It will be further understood that the terms “comprise” and/or “have,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments of the present disclosure belong.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

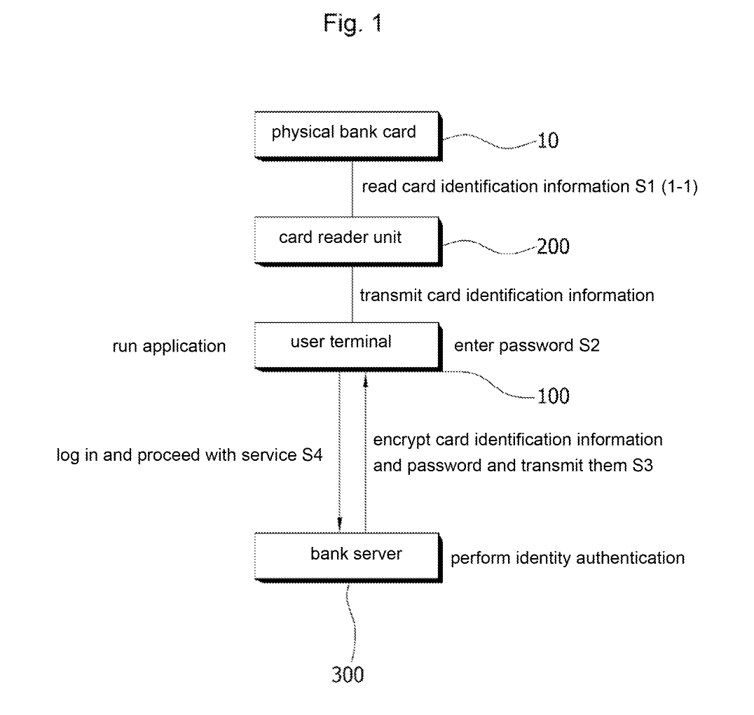

FIG. 1 is a flowchart schematically illustrating an example of identity authentication performed by an online financial transaction identity authentication system using a physical card according to a preferred embodiment of the present invention.

Referring to FIG. 1, an online incompletely attached state using a physical card according to the present invention may include a user terminal 100 and a card reader unit 200. The user terminal 100 may be connected with a bank server 300 through a mobile communication network or wireless Internet to transmit or receive information to/from the bank server 300. The card reader unit 200 may read identification information about a physical bank card 10 when the physical bank card 10 contacts or approaches the card reader unit 200.

The user terminal 100 may receive mobile communication services and Internet services through the mobile communication network or wireless Internet. The user may install programs or applications on the user terminal 100. For example, the user terminal 100 may, in its concept, encompass a personal computer, laptop computer, smartphone, tablet PC, or personal digital assistant (PDA). The user terminal may have an application for smart banking installed thereon and may perform processing related to overall app operations, such as running or ending the application or data entry, delivery, or processing through the application.

The card reader unit 200 may be externally connected to the user terminal 100, or the card reader unit 200 may be installed inside the user terminal 100. The card reader unit 200 may read identification information from a physical bank card 10 which has been issued for a particular bank and input the identification information about the physical bank card 10 to the user terminal 100. The card reader unit may be implemented to have technical components able to read identification information from the physical bank card 10 by contacting or approaching various forms of storage units, e.g., a magnetic part, IC chip, NFC tag, or RFID tag, embedded in the physical bank card 10 to store the identification information about the physical bank card and to transmit the identification information to the user terminal 100.

As a result, the card reader unit 200 may be implemented in various forms. As an example of implementation, the card reader unit 200 may be implemented as a card reader 210 wiredly or wirelessly connected with the user terminal 100 to be able to read the identification information about the bank card by direct contact to the physical bank card and to transmit the identification information to the user terminal 100. As another example of implementation, the card reader unit 200 may be implemented as a proximity communication unit 220 installed inside or outside the user terminal 100 to be able to read the identification information about the bank card by approaching, as well as direct contact to the physical bank card and to transmit the identification information to the user terminal 100, as proposed.

The physical bank card 10 may include all types of existing bank cards capable of storing the user's identification information and performing bank transactions, such as credit cards, check cards, or cash cards connected with the bank account. The identification information about the physical bank card 10 may be information necessary for financial transactions. The identification information about the physical bank card may be all information stored in the storage unit of the physical bank card 10 when the physical bank card 10 is issued, including user information and account information. As necessary, the identification information about the physical bank card may be minimum information necessary financial transactions.

Various embodiments of the card reader unit 200 are described below in greater detail with reference to the drawings.

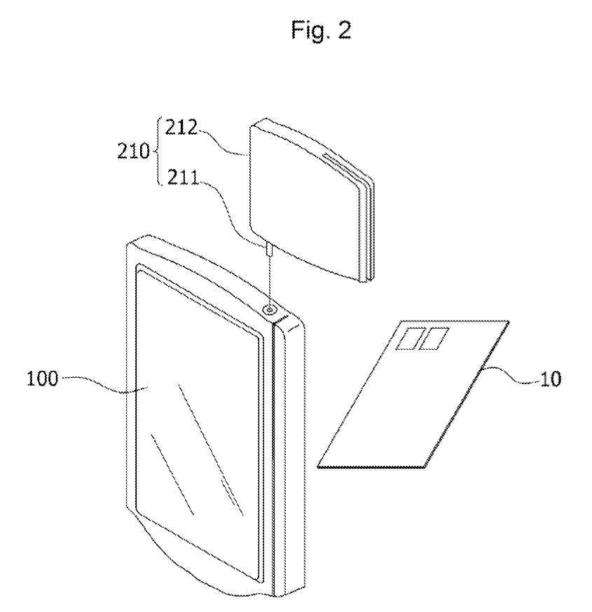

FIG. 2 is a view illustrating a configuration of a card reader externally connected to a user terminal as an example implementation of a card reader unit in an online financial transaction identity authentication system using a physical card according to a preferred embodiment of the present invention.

Referring to FIG. 2, a card reader 210 may include a contact unit 212 capable of reading identification information about the physical bank card 10 when contacted by the physical bank card 10 and a connecting unit 211 connected with the user terminal 100 to transmit identification information about the physical bank card 10 read by the contacting unit 212 to the user terminal.

The connecting unit 211 may be implemented in the form of a wire connected via the earphone terminal, cable connecting terminal, or charging terminal of the user terminal 100, or in some cases, the connecting unit 211 may be connected via wireless communication, such as Bluetooth, NFC, or Wi-Fi. The connecting unit 211 may be connected via other various predictable wired and wireless connecting schemes than the afore-mentioned connecting devices.

The contacting unit 212 may read identification information about the physical bank card 10 from the magnetic part or IC chip of the physical bank card 10. For example, the contacting unit 212 may read the information through the magnetic part of the physical bank card 10 swiped through the contacting unit 212 or read the information through the IC chip embedded in the contacting unit 212.

Although not specifically shown in the drawings, the connecting unit 211 may, as necessary, be configured as a wireless connection via wireless communication, e.g., Bluetooth, NFC, or Wi-Fi, but rather than a wire configuration. In this case, the card reader 210 may receive the identification information about the physical bank card 10 which is read by the contacting unit 212 with the card reader 210 separated from the user terminal 100.

As such, since the card reader 210 is wiredly or wirelessly connected with the user terminal 100 via the connecting unit 211, the identification information about the physical bank card 10 read by the contacting unit 212 may be input to the user terminal 100.

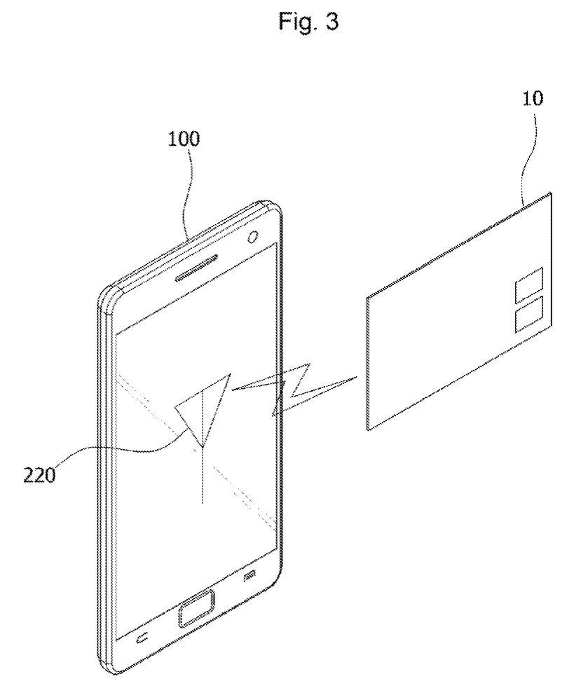

FIG. 3 is a view illustrating a configuration in which a proximity communication unit is installed inside a user terminal as another example implementation of a card reader unit in an online financial transaction identity authentication system using a physical card according to a preferred embodiment of the present invention.

Referring to FIG. 3, a proximity communication unit 22, as the card reader unit 200, is installed inside the user terminal 100. The proximity communication unit 220 may read identification information about the physical bank card 10 that contacts or approaches the user terminal 100 using a short-range wireless communication scheme, e.g., RFID, Bluetooth, NFC, or Wi-Fi Direct. In other words, this is why the identification information about the physical bank card 10 contacting or approaching the user terminal 100 may be read by the proximity communication unit 220 and transmitted to the user terminal 100.

Although not specifically shown, if the proximity communication unit 220 needs to be provided separately from the user terminal 100, such as, e.g., when the proximity communication unit 220, operated as the card reader unit 200, is not embedded in the user terminal 100, the proximity communication unit 220 may be installed outside the user terminal 100.

A bank server 300 connected to be able to transmit or receive information to/from the user terminal 100 may receive identification information about the physical bank card and password from the user terminal 100 and compare pre-stored card information and password with the received information and password to determine whether they match, thereby performing identity authentication. A result of the authentication is fed back to the user terminal 100. If the identity authentication is complete through the application for financial transactions, which is running on the user terminal 100, through the authentication result fed back, and the user logs in, a connection to the bank server may be made through the application. Thus, the bank server 300 may process financial services for the user terminal that has been authenticated and provide the results to the user terminal.

A financial transaction system using a physical card according to the present invention is described below in greater detail in connection with embodiments.

According to a first embodiment of the present invention, the card reader 210 is used, and the connecting unit 211 of the card reader 210 is directly connected to the earphone jack of the user terminal 100. The first embodiment is described below with reference to the drawings.

As shown in FIG. 2, the card reader 210 is directly connected to the user terminal 100 through the connecting unit 211 formed in a side thereof. Unlike shown in the figure, the connecting unit 211 may be connected to the user terminal 100 via the earphone jack connecting terminal, cable connecting terminal, or charging terminal of the user terminal 100. Although not shown, the card reader 210 may also be connected to the user terminal 100 via short-range wireless communication, such as Bluetooth or Wi-Fi.

Referring to FIG. 2, as an implementation example, the connecting unit 211 of the card reader 210 may be projected to be plugged into the earphone jack connecting terminal of the user terminal 100. The contacting unit 212 of the card reader 210 may be configured with a side surface that may contact the magnetic part of the physical bank card 10 to read identification information about the physical bank card 10 stored in the magnetic part of the physical bank card 10.

Meanwhile, according to a second embodiment of the present invention, as another implementation example of the card reader unit 200, the card reader unit 200 may include a proximity communication unit 220 that is embedded and installed in the user terminal 100. The proximity communication unit 220 may read identification information about the printed circuit board 10 that contacts or approaches the user terminal 100 and input the identification information to the user terminal 100.

As shown in FIG. 3, the proximity communication unit 220 may read the identification information about the physical bank card from the physical bank card 10 that contacts or approaches the user terminal 100, particularly, the part of the user terminal 100 where the proximity communication unit 220 is embedded and installed. The proximity communication unit 220 transmits the identification information about the physical bank card, which is read from the physical bank card 10 and transmitted, and a password set by the user of the physical bank card 10, which is input through an application executed on the user terminal 100, to the bank server 300.

In this case, the proximity communication unit 220 may use various short-range wireless communication schemes, which are capable of communicating information when they contact or approach each other, such as NFC or RFID.

Detailed use examples have been described in connection with the first and second embodiments. As set forth above, after the identification information about the physical bank card read by the card reader unit 200 has been transmitted to the user terminal 100, the user terminal 100 transmits the identification information about the physical bank card and the password of the physical bank card input to the user terminal 100 to the bank server 300 via a mobile communication network or Internet. In some cases, the physical bank card identification information and the password may be encrypted by a financial application or other applications which are installed on the user terminal 100, and the encrypted information and password may be transmitted to the bank server 300.

Meanwhile, an identity authentication method using a physical card is described below according to a preferred embodiment of the present invention.

The method is described in greater detail with reference to FIG. 1, which is a flowchart schematically illustrating an example of identity authentication performed by an online financial transaction identity authentication system using a physical card according to a preferred embodiment of the present invention.

An online financial transaction identity authentication method using a physical card through a system according to the present invention may include the steps of: reading identification information about a physical bank card through a card reader unit when an application capable of electronic financial transactions is executed through the user terminal 100 (S1-1 and S1-2); inputting a password of the physical bank card to the user terminal (S2); encrypting the identification information about the physical bank card and the password and transmitting the encrypted information and password to a bank server by the user terminal (S3); and comparing, by the bank server, the transmitted card identification information and password with pre-stored data to perform the identity authentication, and if the identity authentication succeeds, performing login to make a connection with the bank server or complete a transaction (S4).

In other words, if the user executes the application capable of mobile financial transactions through the user terminal 100 to use a financial service, the user terminal 100 guides the user to an authentication screen (login screen) for use of an application service. Here, identity authentication may be carried out as follows according to the present invention, instead of using a certificate for identity authentication.

If the application authentication screen (login screen) is displayed on the screen of the user terminal 100, the step S1 of reading the identification information about the physical bank card through the card reader unit is performed. Step S1 is performed by reading the identification information about the physical bank card and transmitting the read identification information to the user terminal by the card reader unit 200 connected and installed inside or outside the user terminal 100. In other words, if the physical bank card slides, contacts, or approaches the card reader unit 200, the card reader unit 200 may read the identification information about the physical bank card (S1-1) and transmit the read identification information about the physical bank card to the user terminal 100 (S1-2).

Meanwhile, the card reader unit 200 may be in the form of a card reader 210 or a proximity communication unit 220 adopting proximity communication.

If the card reader 210 is used as the card reader unit 200, and the connecting unit of the card reader 210 is a wire, the card reader 210 and the user terminal 100 need to connect together wiredly. Thus, before performing step 1, the step of connecting the card reader unit 200 to the user terminal 100 may be added which is performed by connecting the connecting unit 211 of the card reader 210 to the connecting terminal of the user terminal 100. Further, the step S1 of reading the identification information about the physical bank card through the card reader unit may include the step S1-1 of reading the identification information about the physical bank card 10 from the magnetic part or IC chip part of the physical bank card 10 that is swiped or contacts the contacting unit 212 and the step S1-2 of transmitting the identification information about the physical bank card 10 through the connecting unit 211 to the user terminal 100.

If a proximity communication unit installed inside the user terminal is used as the card reader unit 200, step S1 may include the step S1-1 of reading, by the proximity communication unit, the identification information about the physical bank card from the physical bank card contacting or approaching the proximity communication unit; and the step S1-2 of transmitting the identification information about the physical bank card to the user terminal.

The step of inputting the password of the physical bank card to the user terminal is the step of inputting the password through the user terminal to perform authentication as to whether the physical bank card 10 matches the user if the identification information about the physical bank card is transmitted to the user terminal 100.

The steps of encrypting the identification information about the physical bank card and password and transmitting the encrypted information to the bank server are the steps of encrypting both the bank card identification information entered through the card reader unit 200 and the password directly entered and transmitting the encrypted information to the bank server 300 via a mobile communication network or Internet for authentication purposes.

The bank server 300 may compare the card identification information and password transmitted to the bank server 300 with user data previously stored in the bank server 300 to determine whether the bank card identification information and password match the user data, thereby performing identity authentication. Then, the bank server 300 may provide feedback indicating that the identity authentication has succeeded to the user terminal 100, and resultantly, the user may log in through the application of the user terminal to connect to the bank server or complete the transaction.

As such, the identity authentication system and method according to the present invention may be used anytime when it needs to connect to the bank server 300 for online financial transactions through the application installed on the user terminal 100, e.g., when it logs in for Internet banking or identity verification is required for account-to-account transfer. Thus, according to the present invention, financial services needed in the user terminal 100 may seamlessly be performed even without a certificate.

Meanwhile, as necessary, a limit in use of the customer's card may be set and registered. The bank server 300 may selectively provide tasks depending on the use limit.

For example, the bank server 300 may make a setting as to whether to use a login service through the card reader unit 200. The login service may replace the conventional login via a certificate to use electronic financial services.

As another example, the bank server 300 may determine whether to use the fund-transfer-to-frequent-account service. The fund-transfer-to-frequent-account service is a service in which others' accounts frequently used for fund transfer are registered, and fund transfer is automatically processed by simply allowing the card to be read by the card reader unit for easier fund transfer. This service may replace login via certificate or entry of certificate password as conventional. In other words, information about fund transfer from a first account (the user's account) to a second account (a designated account) may immediately be provided even without entry of information about the transfer account for the registered card. In this case, when transfer to another account is desired, the transfer to the designated account may immediately be canceled, and the desired account may be entered to proceed with fund transfer.

An operational process of an online financial transaction identity authentication system using a physical card according to the present invention may be briefly summarized as follows.

First, the user drives an application for a financial service using his smartphone. When the login screen shows up on the application, the user connects the card reader to the smartphone and allows the identification information about the physical bank card to be read through the card reader unit or proximity communication unit. A password input window then shows up. If the password of the physical bank card is entered to the password input window or the ‘Next’ button is then pressed, the identification information about the bank card and the password are encrypted and sent to the bank server. The bank server compares the identification information about the physical bank card and the password with data registered in the database to proceed with identity authentication, and transmits the results to the smartphone. If they match, login is complete. If the identity authentication is complete and so it logs in, the user may do financial tasks using the smartphone.

The above-described embodiments are merely examples, and it will be appreciated by one of ordinary skill in the art various changes may be made thereto without departing from the scope of the present invention. Accordingly, the embodiments set forth herein are provided for illustrative purposes, but not to limit the scope of the present invention, and should be appreciated that the scope of the present invention is not limited by the embodiments. The scope of the present invention should be construed by the following claims, and all technical spirits within equivalents thereof should be interpreted to belong to the scope of the present invention.

1. A system for online identity authentication using a physical card, the system comprising:
a user terminal having a smart banking application installed thereon, receiving identification information about a physical bank card from a card reader unit to verify validity of the card and user identity, performing identity authentication based on the verified validity of card and user identity, and if the identity authentication is complete, transmitting the received identification information about the physical bank card to a bank server capable of processing a financial task through the smart banking application; and
the card reader unit reading the physical bank card issued from a particular bank and inputting the identification information about the physical bank card to the user terminal.

2. The system of claim 1, wherein the card reader unit includes a contacting unit that, when contacted by the physical bank card, reads the identification information about the physical bank card and a connecting unit connected with the user terminal to transmit the identification information about the physical bank card read by the contacting unit to the user terminal.

3. The system of claim 1, wherein the card reader unit includes a proximity communication unit that may read the identification information about the physical bank card from the physical bank card contacted or approached.

4. A method for online identity authentication when an application capable of an electronic financial transaction is executed on a user terminal, the method comprising the steps of:
reading identification information about a physical bank card through a card reader unit;
inputting a password of the physical bank card to the user terminal;
encrypting the identification information about the physical bank card and the password and transmitting the encrypted information and password to a bank server by the user terminal; and
comparing, by the bank server, the transmitted card identification information and password with pre-stored data to perform the identity authentication, and if the identity authentication succeeds, performing login to make a connection with the bank server or complete a transaction.

5. The method of claim 4, further comprising the step of connecting the card reader unit to the user terminal.

6. The method of claim 4, wherein the card reader unit includes a contacting unit that, when contacted by the physical bank card, reads the identification information about the physical bank card and a connecting unit connected with the user terminal to transmit the identification information about the physical bank card read by the contacting unit to the user terminal.

7. The method of claim 6, wherein the step of connecting the card reader unit to the user terminal is performed by connecting the connecting unit of the card reader unit to a connecting terminal of the user terminal, and wherein the step of reading the identification information about the physical bank card through the card reader unit includes the steps of reading the identification information about the physical bank card from a magnetic part or IC chip part of the physical bank card contacting or swiped through the contacting unit and transmitting the identification information about the physical bank card through the connecting unit to the user terminal.

8. The method of claim 4, wherein the card reader unit is a proximity communication unit embedded and installed in the user terminal.

9. The method of claim 8, wherein the step of reading the identification information about the physical bank card through the card reader unit includes the steps of reading the identification information about the physical bank card from the physical bank card contacting or approaching the proximity communication unit, by the proximity communication unit, and transmitting the identification information about the physical bank card to the user terminal.

10. The method of claim 5, wherein the card reader unit includes a contacting unit that, when contacted by the physical bank card, reads the identification information about the physical bank card and a connecting unit connected with the user terminal to transmit the identification information about the physical bank card read by the contacting unit to the user terminal.
